(19) United States
(12) Patent Application Publication
(10) Pub. No.: US 2007/0127125 A1
(43) Pub. Date: Jun. 7, 2007

(54) Infrared diffractive lens

(75) Inventor: Hironori Sasaki, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/606,002

(22) Filed: Nov. 30, 2006

(30) Foreign Application Priority Data
Dec. 1, 2005 (JP) JP2005-347752

(51) Int. Cl. G02B 5/18

(52) U.S. Cl. 359/569; 359/350

(57) ABSTRACT

This invention provides an infrared diffractive lens capable of focusing infrared rays within a wide range of wavelength band effectively. According to the present invention, there is provided an infrared diffractive lens including a concave-convex shape with predetermined depth defined based on a predetermined standard wavelength in a wavelength band of incident infrared rays, wherein: the incident infrared rays are within the wavelength band of 1.1-16 μm; a depth h of the concave-convex shape is defined by mλ/(n−1) with regard to a refractive index n of material of lens, the standard wavelength λ and a harmonic order m; and the harmonic order m is an integer between 2 and 10. Using the infrared diffractive lens with such a configuration makes it possible to focus infrared rays within a wide range of wavelength band effectively.

### CROSS-REFERENCE TO RELATED APPLICATION

The disclosure of Japanese Patent Application No. JP2005-347752 filed on Dec. 1, 2005, including the specification, drawings and abstract is incorporated herein by reference in its entirety.

### BACKGROUND OF THE INVENTION

The present invention relates to an infrared diffractive lens, and more specifically, an infrared diffractive lens capable of reducing the change of focal length when infrared rays with a wide range of wavelength band enter.

For measuring the temperature of object surface in noncontact method by receiving the infrared rays emitted from a distant object and for detecting a suspicious individual by receiving the infrared rays emitted from a living organism, the demand of infrared sensor is increasing.

FIG. 10 is a schematic diagram describing a conventional infrared sensor schematically. As shown in FIG. 10, a conventional infrared sensor 10 is configured by a dome lens 12 for focusing infrared rays 20 and a sensor part for receiving the infrared rays 20.

The sensor part includes a can package 14 and an infrared receiver 16 provided in the can package. The can package 14 is provided for securing the reliability of the infrared receiver 16 for the influence such as disturbance, and the infrared receiver 16 is sealed in the can package 14 keeping airtight. On one surface of the can package 14, an airtight sealing window 18 for sealing the can package in an airtight state and for transmitting the focused infrared rays 20 is provided.

Outside the sensor part as described above, a lens 12 for focusing the infrared rays 20 emitted from a heating object on the surface of the infrared receiver 16 is provided.

Such a lens 12 is curved in a dome-like shape as shown in FIG. 10 to secure a wide incidence angle and formed by combining plural lenses capable of focusing the incident infrared rays 20 on the infrared receiver 16.

On the other hand, since such a lens is provided outside the can package 14, the infrared sensor 10 itself becomes large. Further, although the lens 12 is formed by injection molding using polyethylene resin as material so as to reduce the price, the light transmission of polyethylene to infrared rays is only 40-50% or so. Therefore, an infrared lens with smaller loss is desired to increase the sensitivity of the infrared sensor 10.

In order to solve the above problems, there is proposed a diffractive lens for infrared rays formed by etching using a substrate such as silicon (for example, refer to Patent Document No. 2713550, hereafter, referred to as Document 1). Since such a lens is extremely thin with the lens part having the same thickness as wavelength, absorption loss caused by the material of lens can be kept at extremely low level, which is a great advantage compared to a general resin lens.

Since plural lenses can be formed collectively on the substrate in the diffractive lens as described above, there is also proposed that the substrate itself such as silicon with the lens corresponding to plural incident directions is used as the airtight sealing window 18 provided at the can package 14 in FIG. 10 (for example, refer to Patent Document No. 3106796, hereafter, referred to as Document 2).

Although, however, the diffractive lens with such a configuration has various characteristics compared to a lens for infrared rays using resin such as polyethylene, there is a problem called aberration where the focal length of lens varies according to wavelength.

FIGS. 11A-11C are schematic diagrams describing the relation between the design wavelength of the diffractive lens and the focal point thereof. The above problem will be described in reference to FIGS. 11A-11C.

In the diffractive lens as described above, a period distribution is designed after determining a design wavelength. For this reason, when such a diffractive lens is used in infrared rays with a wavelength different from the design wavelength, the location of focal point of the diffractive lens is to differ from the location in design. This is because the lens with the focal length f designed at wavelength λ acts as a lens with the focal length f″ defined by the following formula 5 with regard to the wavelength of λ′ different from the design wavelength.

$${f}^{′} = \frac{λ}{{λ}^{′}} f \qquad ( formula 5 )$$

In other words, as shown in FIG. 11A, when infrared rays 50a with the design wavelength enters a diffractive lens 30, the infrared rays 50a focuses light in a receiver 40 located at the location of a focal point f on an optical axis 60. However, as shown in FIG. 11B, when infrared rays 50b with the wavelength shorter than the design wavelength enters, the location of the focal point f becomes more distant than the focal point with the design wavelength. Accordingly, the infrared 50b focuses light at the location on the optical axis 60 more distant than the receiver 40, which deteriorates a light-receiving efficiency of infrared rays at the receiver 40. In addition, as shown in FIG. 11C, when infrared rays 50c with the wavelength longer than the design wavelength enters, the location of the focal point f becomes nearer than the focal point with the design wavelength. Accordingly, the infrared 50c focuses light short of the receiver 40, which also deteriorates a light-receiving efficiency of infrared rays at the receiver 40.

In an infrared sensor used for detecting an intruder from outside in the interests of crime prevention, or for turning on the light by sensing a person entering a room, the above problem becomes serious. This is because the infrared rays emitted according to the human body temperature is distributed in the wavelength of 6-10 μm and it is necessary to receive the infrared rays in such a wide range of wavelength completely so as to increase the sensitivity of sensor.

Therefore, there is desired a diffractive lens which is capable of preventing the change of focal point location even when arbitrary infrared rays in a wide range of wavelength enter and which is used for infrared rays, leaving the characteristics of the diffractive lens as it is.

### SUMMARY OF THE INVENTION

The present invention is achieved in view of the above problems and aims at providing a novel and improved infrared diffractive lens capable of reducing the variation of focal length in the infrared rays in a wide range of wavelength, leaving the characteristics of the diffractive lens as it is.

To solve the above problems, as the result of keen examination on the side of the inventor of the present application, the infrared diffractive lens capable of relieving the wavelength dependence of the focal length of the lens has been invented.

To solve the above problems, in other words, according to an aspect of the present invention, there is provided an infrared diffractive lens including a concave-convex shape with predetermined depth defined based on a predetermined standard wavelength in a wavelength band of incident infrared rays, wherein: the incident infrared rays are within the wavelength band of 1.1-16 μm; a depth h of the concave-convex shape is defined by the following formula 1 with regard to a refractive index n of material of lens, the standard wavelength λ and a harmonic order m; and the harmonic order m is an integer between 2 and 10.

$$h = \frac{m λ}{n - 1} \qquad ( formula 1 )$$

In the infrared diffractive lens with such a configuration, the infrared rays with plural different wavelengths in the wide range of wavelength as described above are focused on the same focal point. As a result, the variation of focal length in the infrared rays in a wide range of wavelength can be reduced and it becomes possible to focus the infrared rays within an entire range of wavelength band effectively.

The concave-convex shape can also be formed by etching. With the formation of concave-convex shape by such a method, the infrared diffractive lens according to the present invention can be formed easily and at low cost.

The concave-convex shape may be formed by transfer molding based on a matrix formed by etching or cutting work. With the formation of concave-convex shape by such a method, the infrared diffractive lens according to the present invention can be mass-produced easily and at low cost.

The incident infrared rays may be within the wavelength band of 6-10 μm. Since this wavelength band is the wavelength band of the infrared rays emitted by a living organism, the infrared rays emitted by the living organism can be focused effectively.

A cross-section surface cut at a plane surface including an optical axis may have a saw-like shape in at least a part of the concave-convex shape. Also, a cross-section surface cut at a plane surface including an optical axis has a stepwise shape of N steps (N is an integer of 3 or more) in at least a part of the concave-convex shape, and the depth h of the concave-convex shape can be approximated by a depth h′ defined by the following formula 2. With such a shape of the cross-section surface of the concave-convex shape, the infrared diffractive lens according to the present invention can be made thin.

$${h}^{′} = \frac{m λ}{n - 1} \times \frac{N - 1}{N} \qquad ( formula 2 )$$

The material of lens with refractive index of 2 or more can also be used. With the use of such material, the depth h of the concave-convex shape can be made small.

The material of lens may be selected from a group including Si, Ge, GaAs, InP and GaP. Since such materials have different wavelength bands for transmitting infrared rays, the wavelength band of infrared rays focused by the infrared diffractive lens according to the present invention can be selected.

Non-reflecting coating may be performed on either the surface or the rear surface of the infrared diffractive lens. Such a non-reflecting coating can prevent from the rate of the transmitted infrared rays from decreasing, with the reflection of the incident infrared rays on the infrared diffractive lens according to the present invention.

According to the present invention, an infrared diffractive lens capable of focusing infrared rays within a wide range of wavelength band effectively can be provided.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1A is a sectional view showing schematically an infrared diffractive lens according to the first embodiment of the present invention.

FIG. 1B is a sectional view showing schematically an infrared diffractive lens according to the second embodiment of the present invention.

FIG. 2A is a schematic diagram describing schematically a depth of a concave-convex shape and an effect thereof.

FIG. 2B is a schematic diagram describing schematically a depth of a concave-convex shape and an effect thereof.

FIG. 2C is a schematic diagram describing schematically a depth of a concave-convex shape and an effect thereof.

FIG. 3 is a graph chart showing a relation between diffraction efficiency of the diffractive lens and harmonic order.

FIG. 4 is a graph chart showing a relation between wavelength of an incident infrared rays and diffraction order thereof.

FIG. 5 is a schematic diagram showing schematically a simulation setting of the infrared diffractive lens according to the present invention.

FIG. 6A is a graph chart showing a relation between diffraction efficiency of a conventional infrared diffractive lens and infrared wavelength.

FIG. 6B is a graph chart showing an efficiency of reception of the infrared rays transmitted through the conventional infrared diffractive lens at an infrared receiver with the above effective opening.

FIG. 7A is a graph chart showing a relation between diffraction efficiency of an infrared diffractive lens according to the first embodiment of the present invention and infrared wavelength.

FIG. 7B is a graph chart showing an efficiency of reception of the infrared rays transmitted through the infrared diffractive lens according to the first embodiment of the present invention at an infrared receiver with the above effective opening.

FIG. 8A is a graph chart showing a relation between diffraction efficiency of an infrared diffractive lens according to the second embodiment of the present invention and infrared wavelength.

FIG. 8B is a graph chart showing an efficiency of reception of the infrared rays transmitted through the infrared diffractive lens according to the second embodiment of the present invention at an infrared receiver with the above effective opening.

FIG. 9A is a graph chart showing a relation between diffraction efficiency of an infrared diffractive lens according to the third embodiment of the present invention and infrared wavelength.

FIG. 9B is a graph chart showing an efficiency of reception of the infrared rays transmitted through the infrared diffractive lens according to the third embodiment of the present invention at an infrared receiver with the above effective opening.

FIG. 10 is a schematic diagram describing schematically a conventional infrared sensor.

FIG. 11A is a schematic diagram describing schematically a relation between a design wavelength of the diffractive lens and a focal point thereof.

FIG. 11B is a schematic diagram describing schematically a relation between a design wavelength of the diffractive lens and a focal point thereof.

FIG. 11C is a schematic diagram describing schematically a relation between a design wavelength of the diffractive lens and a focal point thereof.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

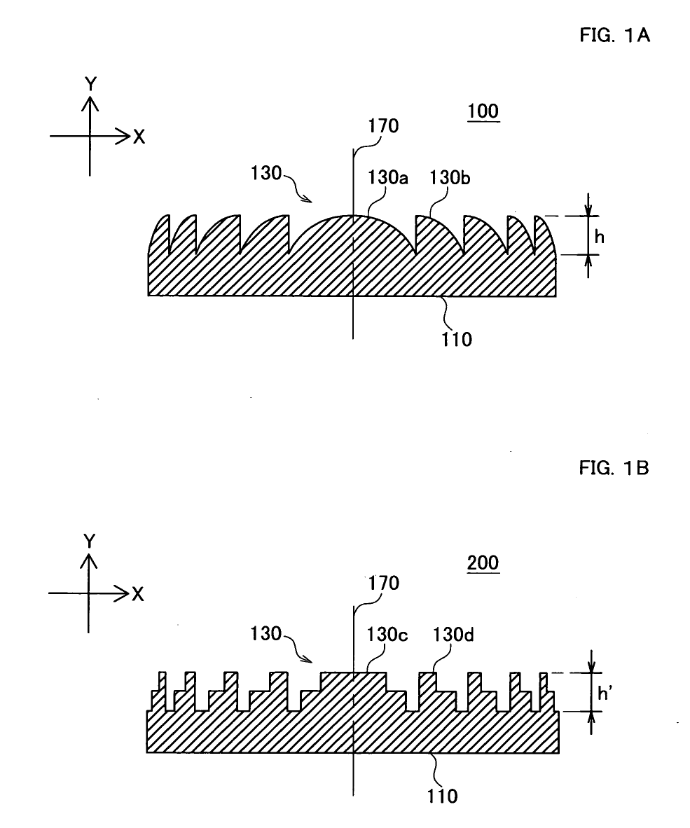

FIG. 1A is a sectional view showing an infrared diffractive lens 100 according to the first embodiment of the present invention cut at the plane surface including an optical axis 170. It should be noted that a coordinate axis described in FIG. 1A is to be used in the following description.

The infrared diffractive lens 100 according to this embodiment is formed by material with refractive index of 2 or more. For example, silicon (Si, refractive index 3.43), germanium (Ge, refractive index 4.01), gallium-arsenide (GaAs, refractive index 3.42), indium-phosphorus (InP, refractive index 3.37) and gallium-phosphorus (GaP, refractive index 3.35) can be used as the material forming the infrared diffractive lens 100. However, the material of the infrared diffractive lens according to the present invention is not limited to these and arbitrary material can be used as long as the refractive index is 2 or more.

With the change of material of the infrared diffractive lens 100, the wavelength band of the transmitted infrared rays can be selected. In the case of using Si as the material, for example, it is possible to transmit selectively the infrared rays with the wavelength at approximately 1.1-16 μm. Also in the case of using Ge, it is possible to transmit selectively the infrared rays with the wavelength at approximately 1.8-23 μm, in the case of using GaAs, it is possible to transmit selectively the infrared rays with the wavelength at approximately 1.0-18 μm, in the case of using InP, it is possible to transmit selectively the infrared rays with the wavelength at approximately 1.0-14 μm, and in the case of using GaP, it is possible to transmit selectively the infrared rays with the wavelength at approximately 0.53-16 μm.

In the infrared diffractive lens 100, as shown in FIG. 1A, a plane surface part 110 is formed on the front surface and a concave-convex part 130 is formed on the rear surface, for example. The infrared rays enter the infrared diffractive lens 100 from the front surface to the positive direction of y-axis. Here, the front surface of the infrared diffractive lens 100 indicates the surface which the infrared rays enter and the rear surface of the infrared diffractive lens 100 indicates the surface which the infrared rays emerge.

The infrared diffractive lens 100 is formed symmetrically with respect to, for example, the optical axis 170. The concave-convex part 130 of the infrared diffractive lens 100 is configured by, for example, a semicircular part 130a and a saw-like shape part 130b. The semicircular part 130a has a predetermined diameter and the center thereof exists on, for example, the optical axis 170. At the outer circumference of the semicircular part 130a, the saw-like shape part 130b is formed. The side surface near the optical axis 170 of each saw-like shape part 130b is formed vertically as shown in FIG. 1A. The side surface distant from the optical axis 170 has a gently-curved surface as shown in FIG. 1A. The entire shape of the infrared diffractive lens 100 seen from the y-axis is, for example, circular and the semicircular part 130a and the saw-like shape part 130b are arranged concentrically.

A height h of the vertical side surface is the value defined by the following formula 1 using a refractive index n of the used lens material, the set standard wavelength λ and a harmonic order m. Here, the harmonic order m is an integer between 2 and 10.

$$h = \frac{m λ}{n - 1} \qquad ( formula 1 )$$

In addition, the horizontal width of each saw-like shape part 130b, i.e., the horizontal width in an x-axis direction is provided so as to, for example, be smaller with distance from the optical axis 170.

FIG. 1B is a sectional view showing an infrared diffractive lens 200 according to the second embodiment of the present invention cut at the plane surface including an optical axis 170. It should be noted that a coordinate axis described in FIG. 1B is to be used in the following description.

The infrared diffractive lens 200 is formed by approximating the same configuration as the concave-convex part 130 of the infrared diffractive lens 100 according to the first embodiment of the present invention by a stepwise shape, and can be formed by using the same material as the infrared diffractive lens 100. In the infrared diffractive lens 200, as shown in FIG. 1B, a plane surface part 110 is formed on the front surface and a concave-convex part 130 is formed on the rear surface, for example. The infrared rays enter the infrared diffractive lens 200 from the front surface to the positive direction of y-axis. Here, the front surface of the infrared diffractive lens 200 indicates the surface which the infrared rays enter and the rear surface of the infrared diffractive lens 200 indicates the surface which the infrared rays emerge.

The infrared diffractive lens 200 is formed symmetrically with respect to, for example, the optical axis 170. The concave-convex part 130 of the infrared diffractive lens 200 is configured by, for example, a rotational symmetry stepwise shape part 130c and a stepwise shape part 130d. The rotational symmetry stepwise shape part 130c has a predetermined diameter and the center thereof exists on, for example, the optical axis 170. At the outer circumference of the rotational symmetry stepwise shape part 130c, the stepwise shape part 130d is formed. Preferably, each of the stepwise shape parts 130c and 130d has at least 3 steps or more. Although, in FIG. 1B, each of the stepwise shape parts 130c and 130d has 3 steps, the number of steps of the infrared diffractive lens according to the present invention is not limited to this example and the stepwise shape with, for example, 4 steps or more is applicable. The entire shape of the infrared diffractive lens 200 seen from the y-axis is, for example, circular and the rotational symmetry stepwise shape part 130c and the stepwise shape part 130d are arranged concentrically.

The height of each of the stepwise shape parts 130c and 130d, i.e., the value of height (h′ in FIG. 1B) from the bottom of the stepwise shape part to the top thereof is calculated by approximating the height h defined by the formula 1 in the first embodiment by the value defined by the following formula 2. Note that N in the formula 2 (N is an integer of 3 or more) indicates the number of steps of the stepwise shape part and FIG. 1B falls under the case of N=3.

$${h}^{′} = \frac{m λ}{n - 1} \times \frac{N - 1}{N} \qquad ( formula 2 )$$

In addition, the horizontal width of each stepwise shape part 130d, i.e., the horizontal width in an x-axis direction is provided so as to, for example, be smaller with distance from the optical axis 170.

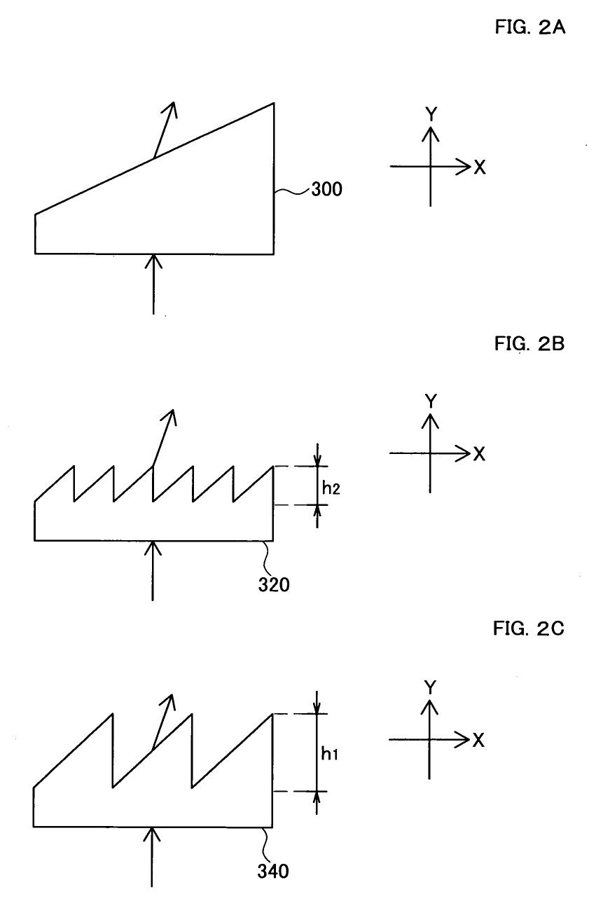

Next, the method of defining the depth h of the concave-convex part 130 and the effect thereof as one of the characteristics in the present invention will be described in reference to FIG. 2. FIG. 2 is a schematic diagram describing schematically the depth of the concave-convex shape and the effect thereof.

FIG. 2A is a side view of a general prism 300 having a function of bending incident light. The prism 300 changes the direction of light entered from a negative region of y-axis according to its wavelength λ and emits the light.

A diffractive lens 320 disclosed in the Documents 1 and 2 has a periodic structure with the prism structure bent at a predetermined depth h₂ as shown in FIG. 2B, so as to realize the same function as in the prism 300 shown in FIG. 2A. The depth h₂ is defined by the following formula 3 with respect to a refractive index n of the used material of lens and the design wavelength λ of the lens.

$${h}_{2} = \frac{λ}{n - 1} \qquad ( formula 3 )$$

As is clear from the formula 3, the above periodic structure shows that, in a unit periodic structure, the phase difference between the incident lights transmitting through the deepest part of a groove and the top part thereof, that is, through the lower end part and the upper end part of h₂ in FIG. 2B is just 1 wavelength (λ). In other words, this periodic structure has a structure where the cross section structure of the prism is bent with 1 wavelength of the design wavelength as a unit. In a diffractive-optical element with such a periodic structure, the incident light propagates diffracted by 100% by a primary diffracted light, and the propagation direction corresponds with the propagation direction of the emitted light bent by the prism 300 in FIG. 2A. However, the light with different wavelength from the design wavelength λ is propagated in a different direction from the propagation direction of the emitted light by the prism 300 in FIG. 2A.

As shown in FIG. 2C, on the other hand, there is an optical element having a periodic structure with a prism structure bent at m (integer) times as the design wavelength λ as a unit, and the optical element is called an m-th order harmonic diffractive-optical element (for example, refer to D. W. Sweeney and G. E. Sommargren. “Harmonic diffractive lenses”. Appl. Opt., 34, pp. 2469-2475 (1995)., hereafter, referred to as Document 3). In other words, the value h₁ in FIG. 2C is the value indicated by the following formula 1. In this m-th order harmonic diffractive-optical element 340, the incident light is diffracted by 100% by an m-th diffraction order, and the diffraction direction corresponds with the diffraction direction by the prism 300 in FIG. 2A.

$$h = \frac{m λ}{n - 1} \qquad ( formula 1 )$$

Further as described above, in the diffractive-optical element, since the depth of bending of the periodic structure corresponds to the phase difference with regard to the incident light λ in the unit periodic structure, there may be the case where h₁ becomes the phase difference k times as the wavelength λ′ different from the incident light λ in the m-th order harmonic diffractive optical element. Here, k is an integer other than m. In other words, there can be plural combinations of k and λ′ satisfying the following formula 4.
mλ=kλ′ (formula 4)

As is clear from the formula 4, there can be plural diffraction orders k with regard to another wavelength λ′ where the incident light is diffracted in the same direction as the design wavelength λ, other than the design wavelength λ, in the m-th order harmonic diffractive-optical element 340. Using this m-th order harmonic diffractive-optical element makes it possible to solve the problem where the focal length of the lens becomes different when the light with a wide range of wavelength enters the diffractive lens.

In the above Document 3, there is reported an example that the same focal length is realized in a visible light range in a wavelength band between 400 nm and 680 nm, shorter than in the infrared rays focused in the present invention, by setting m at 20 or so.

In the infrared diffractive lens according to this embodiment, the m-th order harmonic diffractive-optical element is applied to a wide range of wavelength band of infrared rays. In other words, the periodic structure corresponds to the saw-like shape part 130b or the stepwise shape parts 130c and 130d according to this embodiment. The wavelength band focused in this embodiment is, for example, the wavelength band at 1.1-16 μm. The infrared diffractive lens according to this embodiment can focus effectively a light within an extremely wide range of wavelength band about 50 times as the wavelength band focused in the Document 3.

As described above, with the increase of the harmonic order m, there can be solved a problem of changing the focal length of lens when the light within a wide range of wavelength band enters. However, it is actually very difficult to mass-produce such a high-order harmonic diffractive-optical element at low cost. As a method of mass-producing the diffractive lens at low cost, photolithography and etching are generally used as disclosed in the Documents 1 and 2. With these technologies, however, since the depth of periodic structure is controlled by etching time, a variation is to occur generally at the depth of about 5% even when there is processed as precisely as possible.

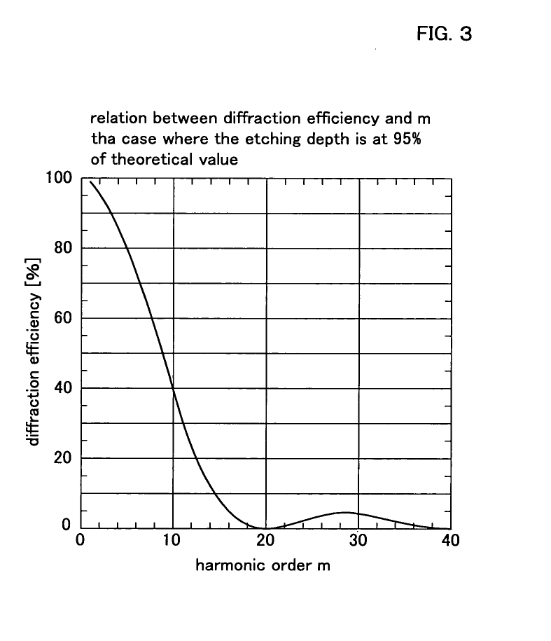

Hereinafter, there will be described a relation between a diffraction efficiency and the harmonic order m in the case of forming a diffractive lens by using etching method. FIG. 3 is a graph chart showing the relation between the diffraction efficiency and the harmonic order m. FIG. 3 shows a result of calculation indicating the change of diffraction efficiency of the harmonic diffractive lens with the depth of concave-convex shape at 95% of a design value h in the case of increasing the harmonic order m.

As is clear from FIG. 3, even when the depth becomes shallower by only 5% than the design value with the increases of harmonic order m and depth of concave-convex shape, the diffraction efficiency deteriorates rapidly. Due to the actual difficulty in forming the lens, in the Document 3, the harmonic diffractive lens with m=20 is manufactured experimentally by using machine cutting technology capable of controlling the depth of concave-convex shape accurately. In the machine cutting technology, however, since it is necessary to manufacture the lens one by one, the problem of mass productivity remains in the case of using this technology.

Further, since the infrared diffractive lens according to the present invention has the wavelength band being focused in the band of infrared rays, the lens with the unit of wavelength in an order of μm and with the harmonic order at m=2 has the depth of concave-convex shape deeper. Accordingly, the control thereof becomes more difficult.

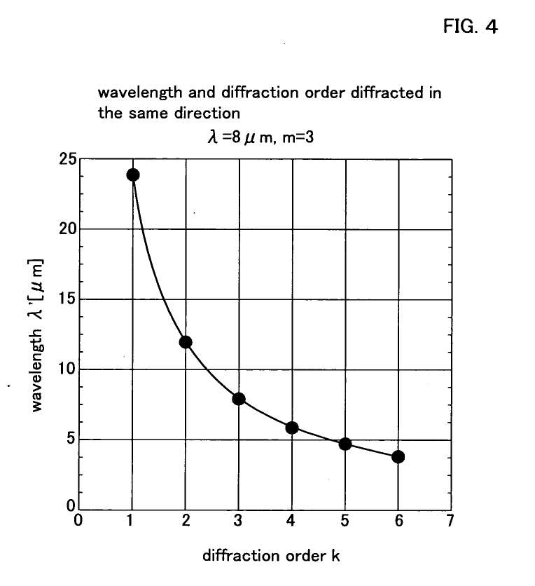

Hereinafter, the relation between the wavelength and the diffraction order that are diffracted in the same direction in reference to FIG. 4. FIG. 4 is a graph chart showing a relation between the wavelength and the diffraction order that are diffracted in the same direction in the infrared diffractive lens in the case where the design wavelength is set at 8 μm and the harmonic order m is set at 3.

In FIG. 4, it can be clarified that there are diffracted in the same direction by 100% the infrared rays with the wavelengths at 24 μm, 12 μm, 6 μm, 4.8 μm and 4 μm at the diffraction order m of 1, 2, 4, 5 and 6 respectively other than the design wavelength and the diffraction order corresponding to the design wavelength, in the case of setting the design wavelength at 8 μm and the harmonic order m at 3. From this result, the inventors of the present invention have discovered that the incident light can be diffracted by 100% in the same diffraction direction in plural wavelengths by using the diffractive lens with harmonic structure, with regard to the wavelength dependency of focal length to be focused in the diffractive lens for infrared rays with a normal structure at m=1 (for example, the lens disclosed in the Documents 1 and 2).

Referring to FIG. 3, the diffraction efficiency of the diffractive lens with the formation error at 95% deteriorates in the case of approximately m=10 to the diffraction efficiency at 40% almost equivalent to the diffraction efficiency of a resin lens in recent widespread use. From this result, the inventors of the present invention have discovered that the there is presented an excellent diffraction efficiency compared to a conventional infrared diffractive lens even in the case of the harmonic order m at approximately 10.

As described above, the inventors of the present invention have clarified that the wavelength dependency of focal length of the lens can be reduced by using a harmonic diffractive-optical element with the harmonic order m at a relatively small value at approximately 10 in the infrared wavelength band to indicate dramatically excellent diffraction efficiency than a conventional lens.

In addition, application of mass production technology at low cost of wafer-scale and going through the following manufacturing process can solve the low degree of mass productivity as the problem with the harmonic diffractive-optical element to improve the mass productivity.

Hereinafter, there will be described a manufacturing method of the infrared diffractive lens according to each embodiment of the present invention.

First, a mask for forming a predetermined concave-convex shape is formed. Next, a matrix is formed by using photolithography method. Further, the concave-convex shape is printed on a substrate with a predetermined material on which a lens is formed by etching, by using this matrix. Non-reflecting coating is performed on at least either the surface or the rear surface of the infrared diffractive lens thus formed. Using such a manufacturing method makes it possible to form the infrared diffractive lens according to each embodiment of the present invention.

In addition, a plurality of infrared diffractive lenses are formed on a predetermined substrate at the same time with the above method, and a plurality of infrared diffractive lenses can be manufactured at low cost in large numbers by wafer-scale, by dicing on the substrate to cut into individual infrared diffractive lenses after the above steps end.

Although an arbitrary etching method may be applied to the above etching method, it is preferable to apply Reactive Ion Etching (RIE).

Also in the above manufacturing method, although there is indicated a method where a matrix is formed by etching and the matrix is printed by etching, the infrared diffractive lens according to this embodiment can be formed by etching without forming a matrix. In addition, the matrix can be formed not by etching but by cutting work.

Hereinafter, specific embodiments of the present invention will be described sequentially. Note that the following embodiments are only for describing specifically the embodiment of the present invention and that the present invention will not be limited by the following embodiments.

(Parameter Setup in Simulation)

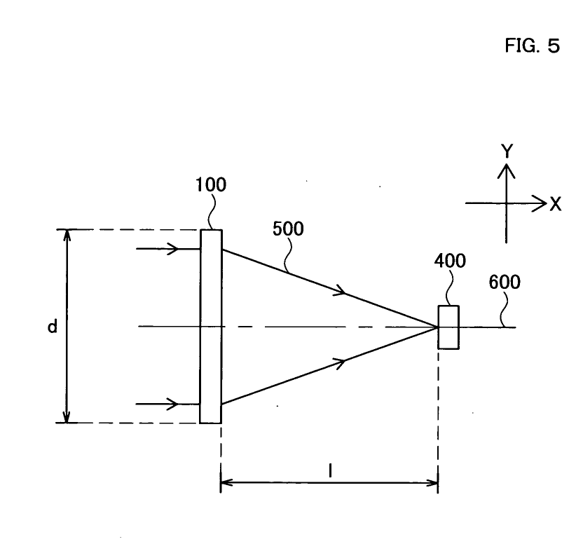

FIG. 5 is a schematic diagram of the optical system used in simulation. An infrared diffractive lens 100 is formed by Si and has a concave-convex portion with saw-like shape shown in FIG. 1A. It is assumed that a diameter d of the infrared diffractive lens is 5 mm and an infrared receiver 400 is provided on an optical axis 600 of the infrared diffractive lens 100. A space 1 between the infrared diffractive lens 100 and the infrared receiver 400 is 5 mm and an effective opening of the infrared receiver 400 has the diameter at 500 μm.

In each embodiment and comparative example, in addition, the wavelength band of an incident infrared 500 is 6-10 μm. This wavelength band is the wavelength band of the infrared rays emitted from a living organism. Therefore, the performance of the infrared diffractive lens with regard to the infrared rays in such a wavelength band becomes important in the case of using the infrared diffractive lens according to this embodiment for organism sensor. The design wavelength of the infrared diffractive lens is 8 μm, which is a typical wavelength emitted from living organisms most.

In the following comparative example and embodiment, the infrared diffractive lens according to this embodiment and a conventional infrared diffractive lens are compared by changing a harmonic order m of the infrared diffractive lens with the above parameter fixed. Note that with the change of the harmonic order m a depth h of the concave-convex shape of the infrared diffractive lens becomes different in each embodiment and comparative example.

Under such a parameter setting, the degree of focusing of infrared rays and phase distribution are simulated by using an easily available optical CAD program.

### COMPARATIVE EXAMPLE

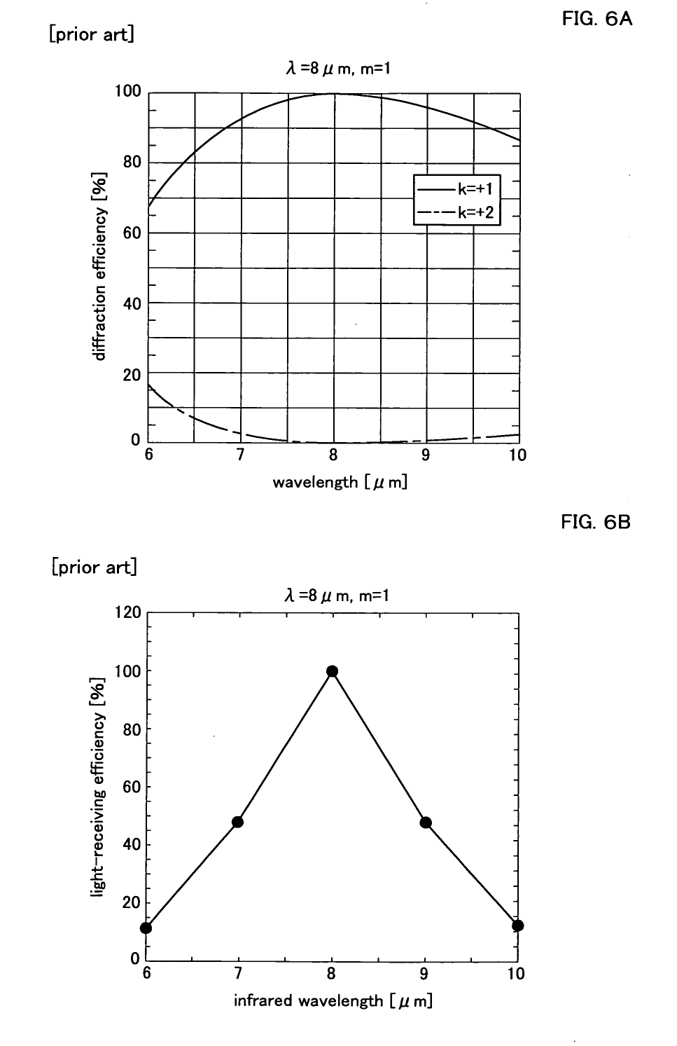

FIGS. 6A and 6B show the simulation result of the case of using the infrared diffractive lens at m=1 corresponding to a conventional infrared diffractive lens. The design wavelength is 8 μm. FIG. 6A is a graph chart showing a relation between diffraction efficiency of the infrared diffractive lens and infrared wavelength. FIG. 6B is a graph chart showing an efficiency of reception of the infrared rays transmitted through the infrared diffractive lens at an infrared receiver with the above effective opening.

Referring to FIG. 6A, there are no wavelengths in the wavelength band at 6-10 μm diffracted in the same direction as 8 μm, the design wavelength. This is also clarified by the fact that in the above formula 4 the value of mλ on the left side is 8 while in the case where k is integer of 2 or more there does not exist λ′ included in the range of 6-10 μm. In FIG. 6A, the case of k=2 is also shown, which shows that a light-receiving efficiency is very low. Also in the case of 8 μm as the design wavelength, diffraction efficiency of the infrared diffractive lens decreases gradually with distance from 8 μm. In addition, the diffraction efficiency of the whole infrared rays transmitted through the infrared diffractive lens is made by overlapping the diffraction efficiency at each diffraction order k in FIG. 6A. In the case of this comparative example, however, the diffraction efficiency at k=1 contributes most among the diffraction efficiencies in the whole infrared rays, and there is little contribution in the case of k=2.

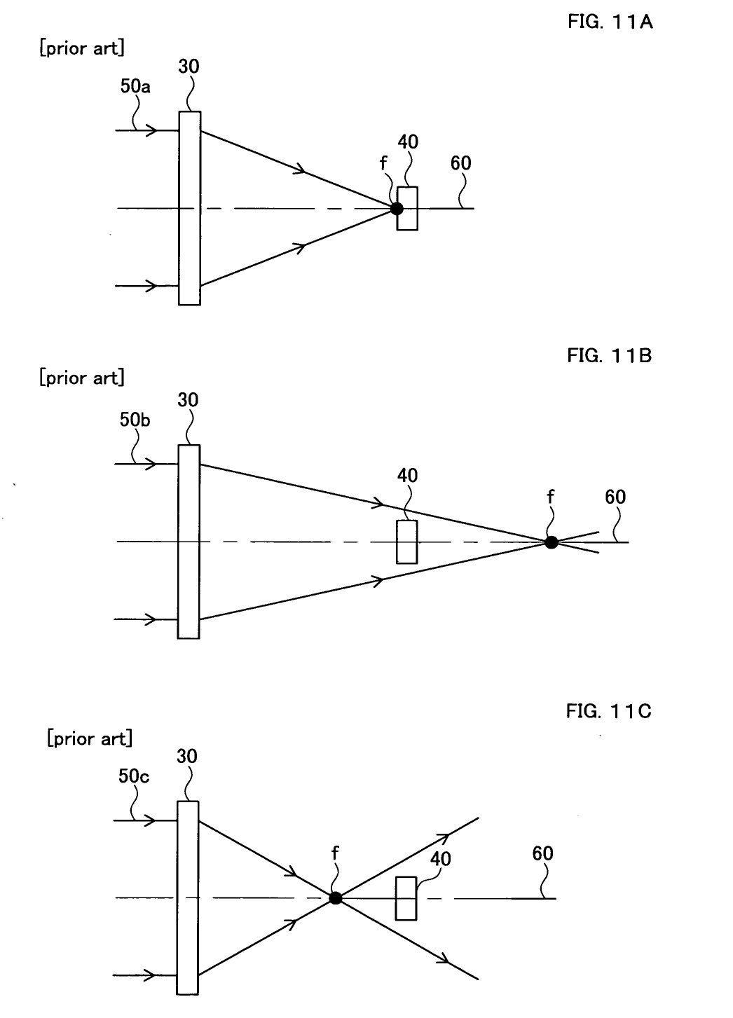

Referring to FIG. 6B, the light-receiving efficiency of the infrared rays at 8 μm as the design wavelength deteriorates significantly with distant from the design wavelength even with the light-receiving efficiency at 100%. The reason that the light-receiving efficiency of the infrared rays other than the design wavelength deteriorates more than the value of the diffraction efficiency of the infrared diffractive lens in FIG. 6A is, as shown in FIGS. 11B and 11C, that the focal length of the lens changes with the change of wavelength and the light flux of the infrared rays that are not captured at the infrared receiver is to increase.

### First Embodiment

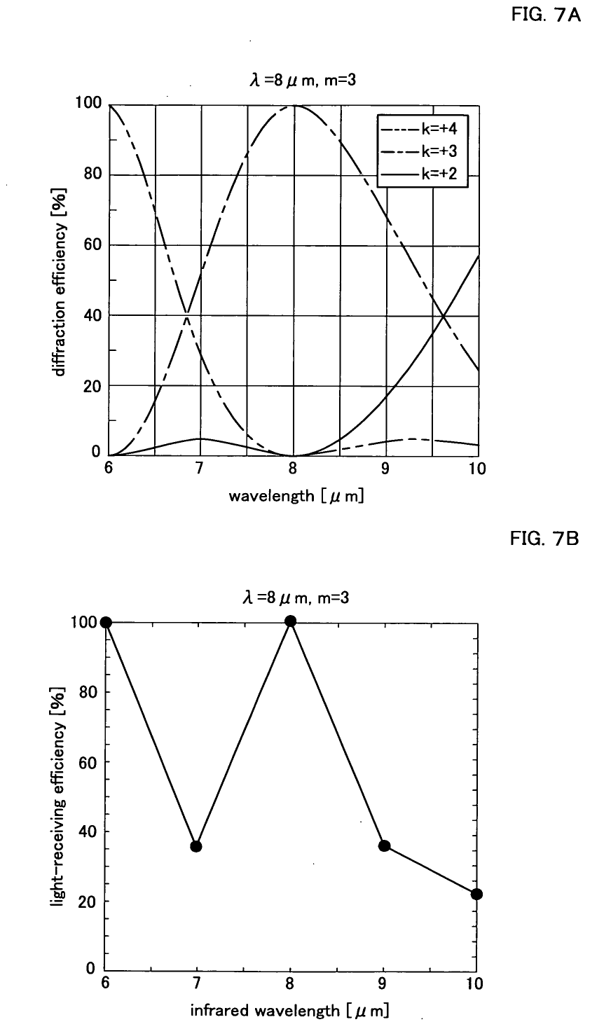

Simulation is performed similarly to the comparative example except that the design wavelength of the harmonic order m of the infrared diffractive lens 100 is set at 3. FIGS. 7A and 7B show the simulation result. FIG. 7A is a graph chart showing a relation between diffraction efficiency of the infrared diffractive lens and infrared wavelength. FIG. 7B is a graph chart showing an efficiency of reception of the infrared rays transmitted through the infrared diffractive lens at an infrared receiver.

Referring to FIG. 7A, the diffraction efficiency also becomes 100% at 6 μm (diffraction order k=4) as well as 8 μm of the design wavelength (diffraction order k=3) and there is diffracted in the same diffraction direction as the infrared rays with the wavelength at 8 μm. In addition, the infrared rays at k=4 also contributes greatly as well as the infrared rays at k=3 among the diffraction efficiencies in the whole infrared rays transmitted actually through the infrared diffractive lens.

Referring to FIG. 7B, the diffraction efficiency also becomes 100% at 6 μm as well as 8 μm of the design wavelength. Also, compared to the comparative example (m=1), the light-receiving efficiency improves in the whole wavelength band at 6-10 μm.

### Second Embodiment

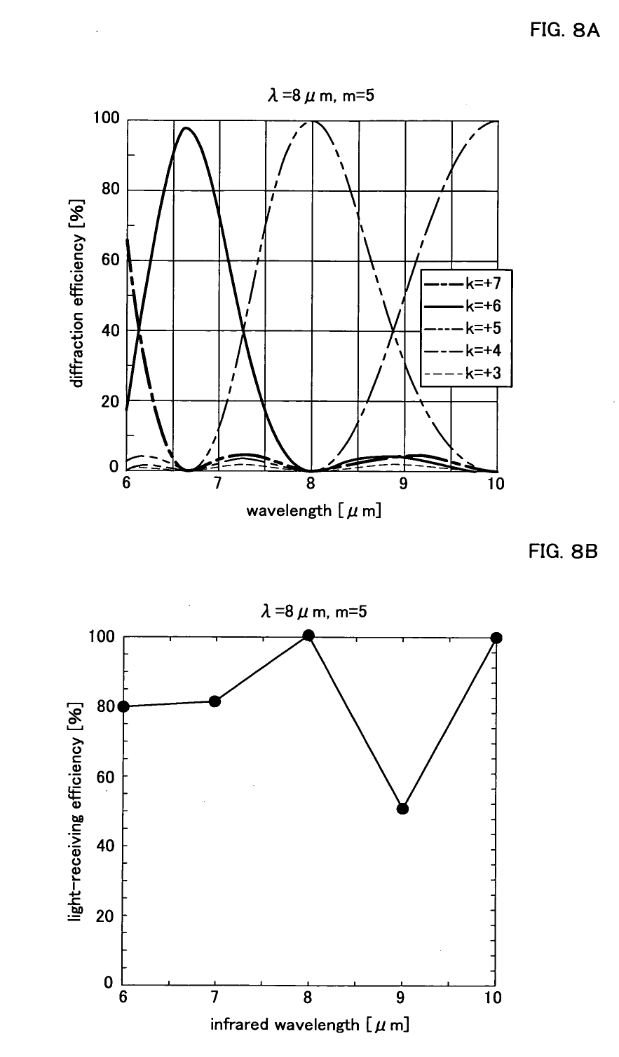

Simulation is performed similarly to the comparative example except that the design wavelength of the harmonic order m of the infrared diffractive lens 100 is set at 5. FIGS. 8A and 8B show the simulation result. FIG. 8A is a graph chart showing a relation between diffraction efficiency of the infrared diffractive lens and infrared wavelength. FIG. 8B is a graph chart showing an efficiency of reception of the infrared rays transmitted through the infrared diffractive lens at an infrared receiver.

Referring to FIG. 8A, the diffraction efficiency also becomes 100% at 6.6 μm (diffraction order k=6) and 10 μm (diffraction order k=4) as well as 8 μm of the design wavelength (diffraction order k=5) and the infrared rays with the wavelengths of 6.6 μm and 10 μm are diffracted in the same diffraction direction as in the infrared rays with the wavelength at 8 μm.

Referring to FIG. 8B, compared to the first embodiment (m=3), the light-receiving efficiency improves significantly in the whole wavelength band at 6-10 μm.

### Third Embodiment

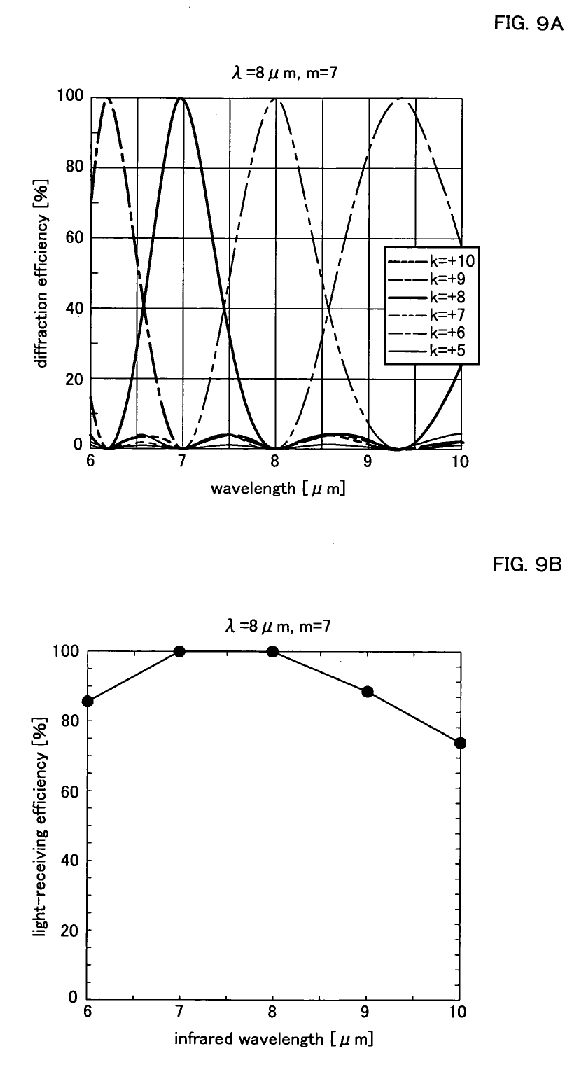

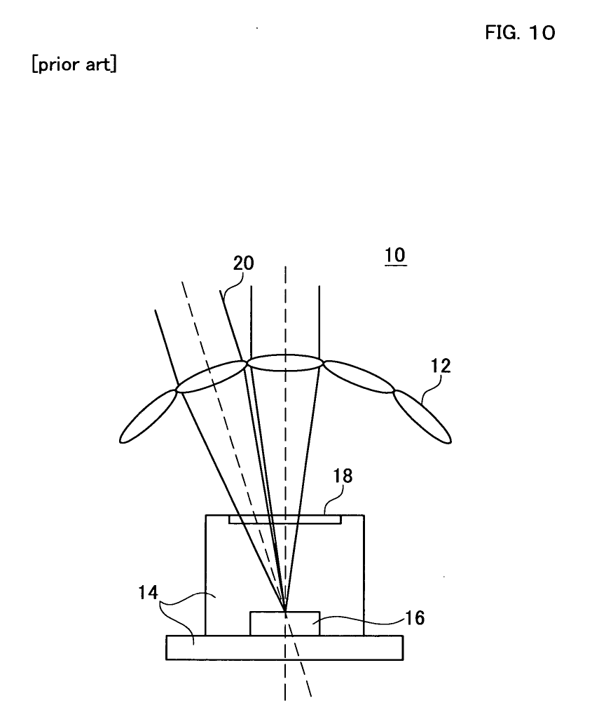

Simulation is performed similarly to the comparative example except that the design wavelength of the harmonic order m of the infrared diffractive lens 100 is set at 7. FIGS. 9A and 9B show the simulation result. FIG. 9A is a graph chart showing a relation between diffraction efficiency of the infrared diffractive lens and infrared wavelength. FIG. 9B is a graph chart showing an efficiency of reception of the infrared rays transmitted through the infrared diffractive lens at an infrared receiver.

Referring to FIG. 9A, the diffraction efficiency also becomes 100% at least at four wavelengths of 6.2 μm (diffraction order k=9), 7 μm (diffraction order k=8) and 9.4 μm (diffraction order k=6) as well as 8 μm of the design wavelength (diffraction order k=7) and the infrared rays with the four wavelengths are diffracted in the same diffraction direction.

Referring to FIG. 9B, there can be obtained the light-receiving efficiency at 80% or higher in the wavelength band at 6-9 μm and the light-receiving efficiency at 75% in the wavelength at 9-10 μm. From this, a significantly preferable light-receiving efficiency can be obtained in the whole wavelength band at 6-10 μm by using the infrared diffractive lens according to this embodiment.

In each embodiment, there has been described focusing the wavelength band at 6-10 μm among the wavelength ranges of the infrared rays transmitted through Si. However, preferable diffraction efficiency and light-receiving efficiency can be obtained by properly changing the harmonic order m also in the wavelengths other than the above ones at 1.1-6 μm and 10-16 μm.

Also in the above description, although simulation has been performed assuming that the infrared diffractive lens is formed by Si, it goes without saying that a preferable result can be obtained similarly to each of the above embodiments even when the infrared diffractive lens is formed by Ge, GaAs, InP or GaP. Further, although simulation has been performed assuming that the concave-convex shape of the infrared diffractive lens has a saw-like shape, it goes without saying as well that the concave-convex shape may have a stepwise shape.

In the wavelength band classified as infrared rays as described above, it has been clarified that a diffractive-optical element having a relatively low-order harmonic order m has the same focal length with regard to a plurality of wavelengths in a wide range of wavelength band and is very useful.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

For example, in the above embodiments, although there has been described the case where the infrared diffractive lens has a cross-sectional shape symmetric with respect to y-axis, the infrared diffractive lens may have a shape asymmetric with respect to y-axis with the direction of the incident infrared rays.

Further in each embodiment described above, although the case where the refractive index of material of lens is 2 or higher, the refractive index of material thereof may be lower than 2.

According to the present invention as described above, there can be provided an infrared diffractive lens capable of focusing infrared rays within a wide range of wavelength band effectively.

In addition, the present invention can be applied to an infrared diffractive lens capable of reducing the change of focal length when infrared rays with a wide range of wavelength band enter.

What is claimed is:

1. An infrared diffractive lens including a concave-convex shape with predetermined depth defined based on a predetermined standard wavelength in a wavelength band of incident infrared rays, wherein:
the incident infrared rays are within the wavelength band of 1.1-16 μm;
a depth h of the concave-convex shape is defined by formula 1 with regard to a refractive index n of material of lens, the standard wavelength λ and a harmonic order m,
$$h = \frac{m λ}{n - 1} ; \qquad ( formula 1 )$$
and
the harmonic order m is an integer between 2 and 10.

2. The infrared diffractive lens according to claim 1, wherein the concave-convex shape is formed by etching.

3. The infrared diffractive lens according to claim 1, wherein the concave-convex shape is formed by reactive ion etching.

4. The infrared diffractive lens according to claim 1, wherein the concave-convex shape is formed by transfer molding based on a matrix formed by etching.

5. The infrared diffractive lens according to claim 1, wherein the concave-convex shape is formed by transfer molding based on a matrix formed by cutting work.

6. The infrared diffractive lens according to claim 1, wherein the incident infrared rays are within the wavelength band of 6-10 μm.

7. The infrared diffractive lens according to claim 1, wherein a cross-section surface cut at a plane surface including an optical axis has a saw-like shape in at least a part of the concave-convex shape.

8. The infrared diffractive lens according to claim 1, wherein:
a cross-section surface cut at a plane surface including an optical axis has a stepwise shape of N steps (N is an integer of 3 or more) in at least a part of the concave-convex shape; and
the depth h of the concave-convex shape is approximated by a depth h′ defined by formula 2.
$${h}^{′} = \frac{m λ}{n - 1} \times \frac{N - 1}{N} \qquad ( formula 2 )$$

9. The infrared diffractive lens according to claim 1, wherein the material of lens with refractive index of 2 or more is used.

10. The infrared diffractive lens according to claim 1, wherein the material of lens is selected from a group including Si, Ge, GaAs, InP and GaP.

11. The infrared diffractive lens according to claim 1, wherein non-reflecting coating is performed on the surface of the infrared diffractive lens.

12. The infrared diffractive lens according to claim 1, wherein non-reflecting coating is performed on the rear surface of the infrared diffractive lens.

13. The infrared diffractive lens according to claim 1, wherein non-reflecting coating is performed on the surface and the rear surface of the infrared diffractive lens.
